(19) United States
(12) Patent Application Publication
(10) Pub. No.: US 2009/0017187 A1
(43) Pub. Date: Jan. 15, 2009

(54) COATED CLOTHS AND METHODS FOR MANUFACTURING THE SAME

(75) Inventor: Jianquan Li, Shenzhen City (CN)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: WINNER INDUSTRIES (SHENZHEN) CO., LTD., Shenzhen City (CN)

(21) Appl. No.: 12/170,338

(22) Filed: Jul. 9, 2008

(30) Foreign Application Priority Data
Jul. 10, 2007 (CN) 200710129415.9

(51) Int. Cl. B32B 27/04

(52) U.S. Cl. 427/2.3; 442/88

(57) ABSTRACT

Disclosed are coated cloths and methods for manufacturing the same. The coated cloth can be used to manufacture medical gowns or drapes to prevent cross-infection between the patient and other people in an operation room.

This application claims the benefit of Chinese Patent Application No. 200710129415.9, filed Jul. 10, 2007, which is incorporated herein by reference in its entirety.

### FIELD

This invention is directed to cloths and particularly to coated cloths.

### BACKGROUND

Conventional medical cloths including surgical gowns and drapes are generally manufactured with a non-woven fabric that is compact, soft and non-irritating. However, the conventional medical cloths normally are not waterproof. As such, during an operation, blood or a body fluid of a patient may soak through the surgical gowns or drapes, and cause possible cross-infection to other people in the operation room.

### SUMMARY

To address the problem in the art, one aspect of the present invention is directed to a cloth comprising a fabric and a coating covering at least a portion of the fabric. The coating is waterproof and breathable and is cross-linked to the fabric to prevent the coated portion of the fabric from being soaked through by a liquid.

Another aspect of the present invention is directed to a method for manufacturing a cloth including: providing a fabric; coating at least a portion of the fabric with a waterproof and breathable coating material; and subjecting the coated fabric to a temperature such that the coating material is cross-linked to the fabric.

In one embodiment, the cloth provided herein prevents a liquid such as water, alcohol, blood and oil from soaking through the cloth. Therefore, the cloth can be used for a disposable protective clothing and its accessories such as insulation garments, experimental clothing, protective hats, shoe covers and oversleeves, as well as household protective articles such as bed sheets, pillowcases, tablecloths, and spread sheets.

In some embodiments, the cloth provided herein is used to make medical articles such as surgical gowns and drapes which can protect the people performing the operation from being infected by the body fluids of the patient.

### BRIEF DESCRIPTION OF THE DRAWINGS

FIG. 1 is a schematic diagram illustrating a cloth according to an embodiment of the present invention; and

FIG. 2 is a schematic diagram illustrating a cloth according to another embodiment of the present invention.

### DETAILED DESCRIPTION

The practice of the present invention will employ, unless otherwise indicated, conventional methods within the skill of the art. Such techniques are explained fully in the literature. All publications, patents and patent applications cited herein, whether supra or infra, are hereby incorporated by reference in their entirety.

The primary object of the present invention is to provide a cloth comprising a fabric and a coating covering at least a portion of the fabric.

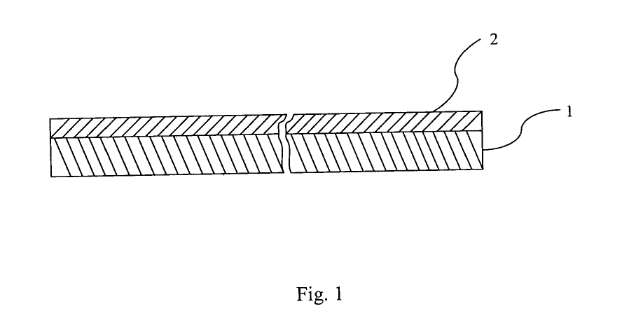

FIG. 1 is a schematic diagram illustrating a cloth according to an embodiment of the present invention. The cloth comprises a fabric 1 and a coating 2 covering one side of the fabric 1.

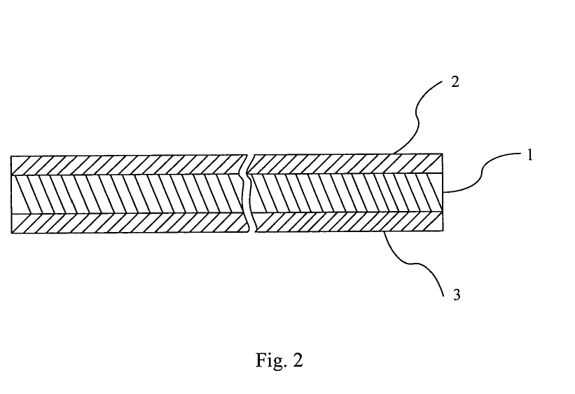

FIG. 2 shows a cloth according to another embodiment. In this embodiment, coatings 2 and 3 cover both sides of the fabric 1.

The fabric 1 can be any fabric suitable as a clothing material. Examples of the fabric 1 include, but are not limited to, spunlaced non-woven fabrics that are made of cotton, synthetic polymer fibers, or mixtures thereof. Synthetic fibers are well-known to a skilled artisan. Examples of synthetic polymer fibers include, but are not limited to, polypropylene fibers, polyester fibers, and mixtures thereof. Preferably, the fabric 1 is made of cotton which is comfortable and nonirritating.

The coating 2 and coating 3 are waterproof and breathable. In one embodiment, the coating 2 and coating 3 contain the same coating material. In another embodiment, the coating 2 and the coating 3 contain different coating materials. Examples of the coating materials include, but are not limited to, polytetrafluoroethylene, polyurethane, acrylate and mixtures thereof. In one embodiment, the coating 2 and coating 3 are both polytetrafluoroethylene coatings. In another embodiment, the coating 2 and coating 3 are both polyurethane coatings. In another embodiment, coating 2 is a polytetrafluoroethylene coating and coating 3 is a polyurethane coating.

In one embodiment, the cloth provided herein is used to manufacture different medical articles such as surgical gowns and coated surgical drapes.

Another aspect of the present invention relates to a method for preparing the cloth as provided herein. The method comprises coating a fabric with a coating material that covers at least a portion of the fabric; and subjecting the coated fabric to a temperature such that the coating material is cross-linked to fiber of the fabric.

The coating step in the method can be performed by rotary-screen-printing-coating, roll-coating, flow-coating, foam-coating, spray-coating, blade-coating, transfer-coating or a combination thereof.

The coated fabric is dried in a drying process. In one embodiment, the drying process utilizes radiation drying, blast-heating drying, cylinder-drying or a combination thereof.

The dried coated fabric is then treated at a temperature high enough to cross-link the coating material to the fiber of the fabric. This cross-linking process can be performed by a heated blast. The cross-linking temperature is selected based on the specific fabric material and coating material used in each specific application, and is typically in the range of 100 to 200° C.

In one embodiment, the fabric 1 is a spunlaced non-woven fabric made of cotton and a synthetic polymer. In another embodiment, the synthetic polymer is polypropylene or polyester fiber. In another embodiment, the spunlaced non-woven fabric comprises 65%-95% cotton and 35%-5% synthetic polymers. Compared to a spunlaced non-woven fabric made of cotton, a spunlaced non-woven fabric with cotton and a synthetic polymer has a lower cost and a better anti-crease performance.

The above description is for the purpose of teaching the person of ordinary skill in the art how to practice the present invention, and it is not intended to detail all those obvious modifications and variations of it which will become apparent to the skilled worker upon reading the description. It is intended, however, that all such obvious modifications and variations be included within the scope of the present invention, which is defined by the following claims. The claims are intended to cover the claimed components and steps in any sequence which is effective to meet the objectives there intended, unless the context specifically indicates to the contrary.

What claimed is:

1. A cloth comprising a fabric and a waterproof and breathable coating covering at least a portion of the fabric, wherein the coating is cross-linked to the fabric so that a liquid cannot soak through the coated portion of the fabric.

2. The cloth of claim 1, wherein the coating is selected from the group consisting of a polytetrafluoroethylene coating, a polyurethane coating, an acrylate coating and a combination thereof.

3. The cloth of claim 2, wherein the fabric is a spunlaced non-woven fabric.

4. The cloth of claim 3, wherein the spunlaced non-woven fabric is made of cotton or cotton and a synthetic polymer.

5. The cloth of claim 4, wherein the spunlaced non-woven fabric is made of 65%-95% cotton and 35%-5% synthetic polymer.

6. The cloth of claim 1, wherein the cloth is used for manufacturing a medical gown or drape.

7. A method for manufacturing a cloth, comprising:
a) providing a fabric;
b) coating at least a portion of the fabric with a waterproof and breathable coating material; and
c) subjecting the coated fabric to a high temperature such that the coating is cross-linked to the fabric.

8. The method of claim 6, wherein said step c) is performed by a heated blast having a temperature ranging from 100° to 200° C.

9. The method of claim 7, wherein said step b) is performed by a rotary-screen-printing-coating, a roll-coating, a flow-coating, a foam-coating, a spray-coating, a blade-coating or a transfer-coating.

10. The method of claim 7, wherein the coating material is selected from polytetrafluoroethylene, polyurethane, acrylate, and mixtures thereof.
